(19) United States
(12) Patent Application Publication
(10) Pub. No.: US 2026/0349788 A1
(43) Pub. Date: Nov. 5, 2026

(54) LINKING DELEGATED TASKS

(71) Applicant: ARM LIMITED, Cambridge, Cambridgeshire (GB)

(72) Inventors: Mbou EYOLE, Soham (GB); Richard Roy GRISENTHWAITE, Cambridge (GB); Robert Gwilym DIMOND, Cambridge (GB)

(73) Assignee: Arm Limited, Cambridge (GB)

(21) Appl. No.: 19/488,991

(22) PCT Filed: Mar. 5, 2024
(86) PCT No.: PCT/GB2024/050586

§ 371 Date: Dec. 1, 2025

(30) Foreign Application Priority Data
Jun. 5, 2023 (GB) 2308377.7

(51) Int. Cl. G06F 9/48

(52) U.S. Cl. CPC G06F 9/4881

(57) ABSTRACT

There is provided an apparatus for data processing. A data processing pipeline executes one or more data processing operations. Extension processing circuitry associated with the data processing pipeline executes one or more delegated tasks and event processing circuitry causes at least one of the one or more delegated tasks and/or the one or more data processing operations to begin execution based on an event indicated by a linking instruction. The extension processing circuitry performs the one or more delegated tasks asynchronously to the one or more data processing operations performed by the data processing pipeline.

The present techniques relate to an apparatus, a method of operating an apparatus, a computer program, and a computer-readable medium.

An apparatus may comprise a data processing pipeline configured to perform data processing operations in dependence on a received sequence of instructions as well as an extension processing circuitry associated with the data processing pipeline and configured to execute one or more delegated tasks. It is desirable to allow the delegated tasks and the data processing operations to be linked, e.g. so that execution of one can lead to execution of another.

Viewed from a first example configuration, there is provided an apparatus for data processing, comprising: a data processing pipeline configured to execute one or more data processing operations; extension processing circuitry associated with the data processing pipeline and configured to execute one or more delegated tasks; and event processing circuitry configured to cause at least one of the one or more delegated tasks and/or the one or more data processing operations to begin execution based on an event indicated by a linking instruction, wherein the extension processing circuitry is configured to perform the one or more delegated tasks asynchronously to the one or more data processing operations performed by the data processing pipeline.

Viewed from a second example configuration, there is provided a data processing method, comprising: setting up one or more data processing operations in a data processing pipeline; setting up one or more delegated tasks in extension processing circuitry associated with the data processing pipeline; and causing at least one of the one or more delegated tasks and/or the one or more data processing operations to begin execution based on an event indicated by a linking instruction, wherein the one or more delegated tasks are executed asynchronously to the one or more data processing operations performed by the data processing pipeline.

Viewed from a third example configuration, there is provided a computer program for controlling a host data processing apparatus to provide an instruction execution environment comprising: data processing pipeline program logic configured to execute one or more data processing operations; extension processing program logic associated with the data processing pipeline program logic and configured to execute one or more delegated tasks; and event processing program logic configured to cause at least one of the one or more delegated tasks and/or the one or more data processing operations to begin execution based on an event indicated by a linking instruction, wherein the extension processing program logic is configured to perform the one or more delegated tasks asynchronously to the one or more data processing operations performed by the data processing pipeline program logic.

Viewed from a fourth example configuration, there is provided a non-transitory computer-readable medium to store computer-readable code for fabrication of an apparatus for data processing, comprising: a data processing pipeline configured to execute one or more data processing operations; extension processing circuitry associated with the data processing pipeline and configured to execute one or more delegated tasks; and event processing circuitry configured to cause at least one of the one or more delegated tasks and/or the one or more data processing operations to begin execution based on an event indicated by a linking instruction, wherein the extension processing circuitry is configured to perform the one or more delegated tasks asynchronously to the one or more data processing operations performed by the data processing pipeline.

The present technique will be described further, by way of example only, with reference to embodiments thereof as illustrated in the accompanying drawings, in which:

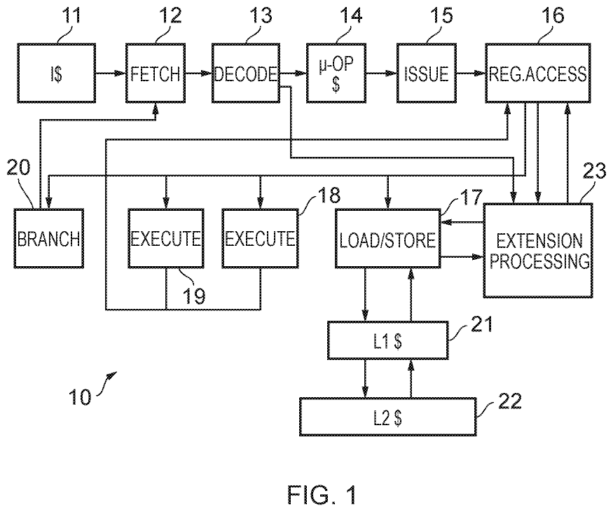

FIG. 1 schematically illustrates a data processing apparatus which may embody various examples of the present techniques;

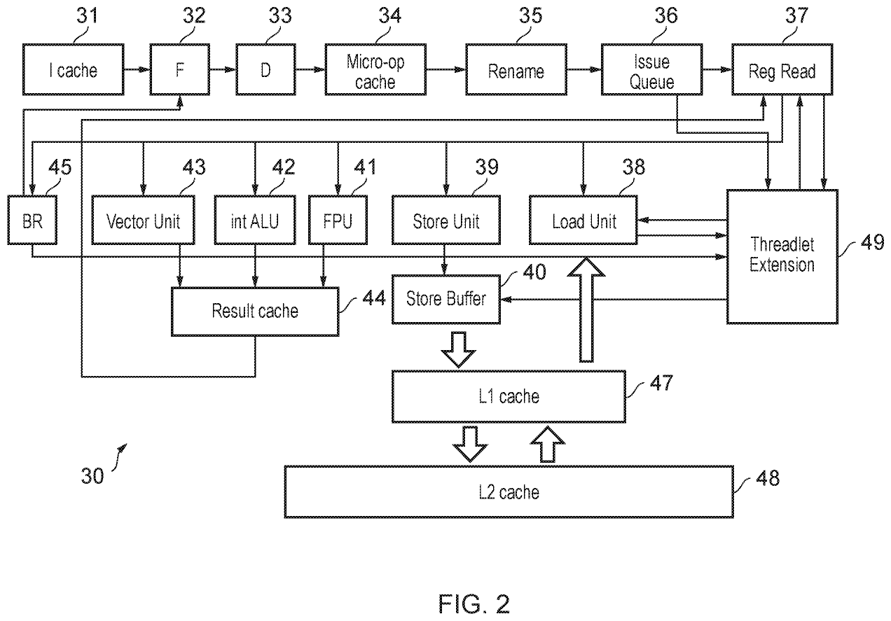

FIG. 2 schematically illustrates a data processing apparatus which may embody various examples of the present techniques;

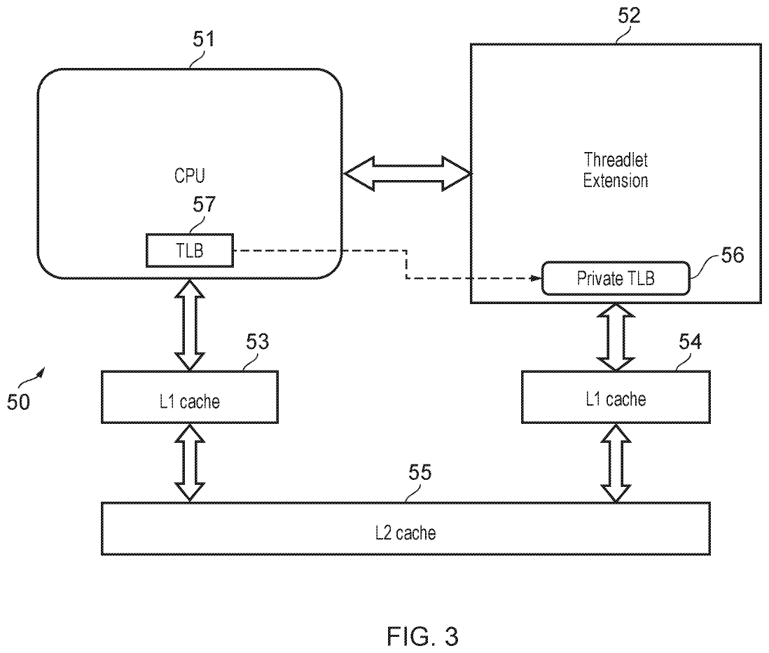

FIG. 3 schematically illustrates a data processing apparatus which may embody various examples of the present techniques;

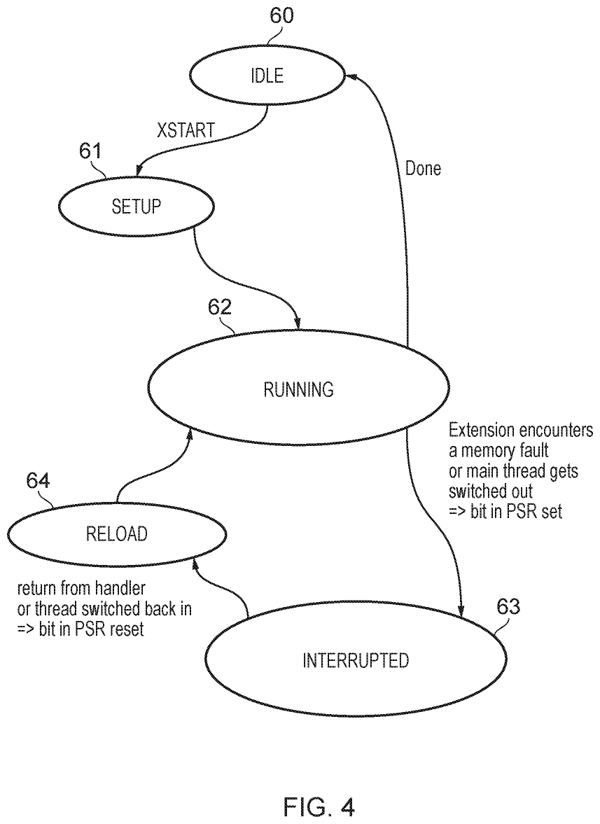

FIG. 4 is a state diagram illustrating an example set of states between which extension processing circuitry of the present techniques may transition;

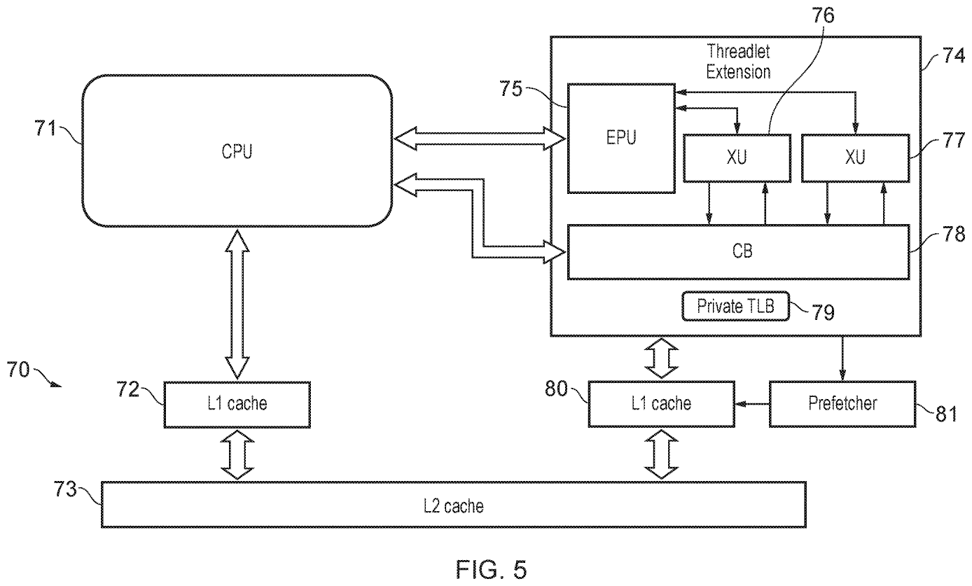

FIG. 5 schematically illustrates a data processing apparatus which may embody various examples of the present techniques;

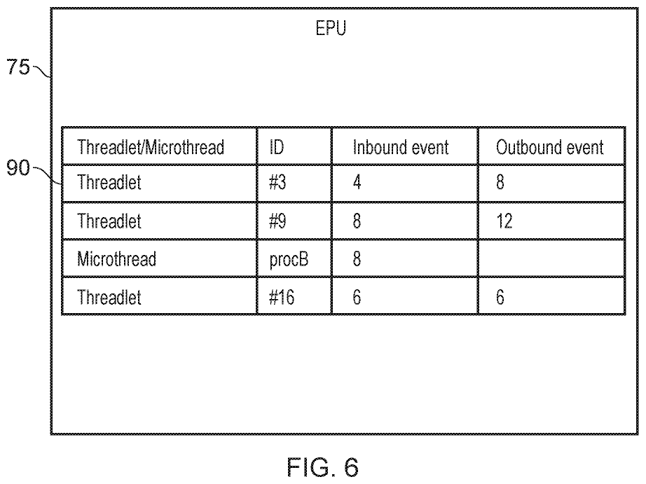

FIG. 6 shows an example of the event processing unit (EPU) and its storage of process dependencies;

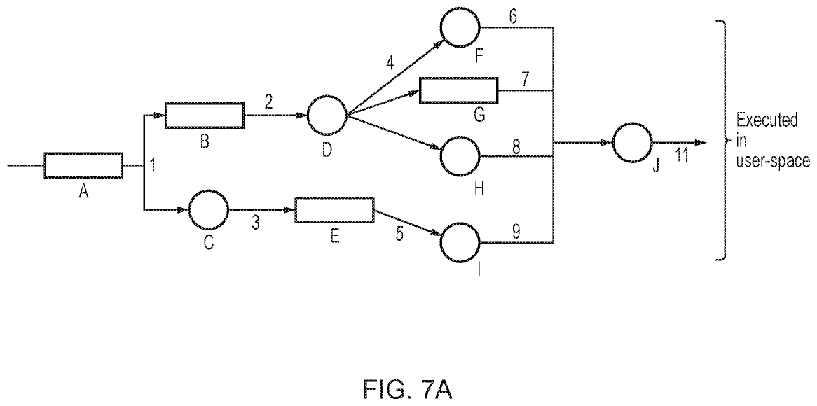

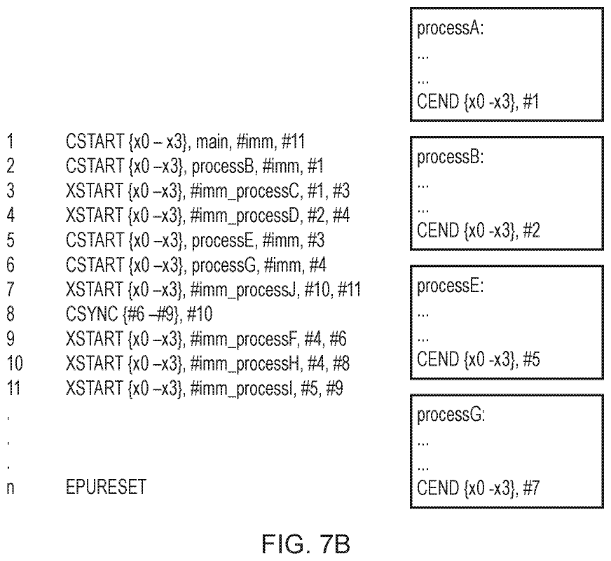

FIG. 7A shows a dataflow graph and FIG. 7B shows corresponding code examples for a program made up of microthreads and threadlets;

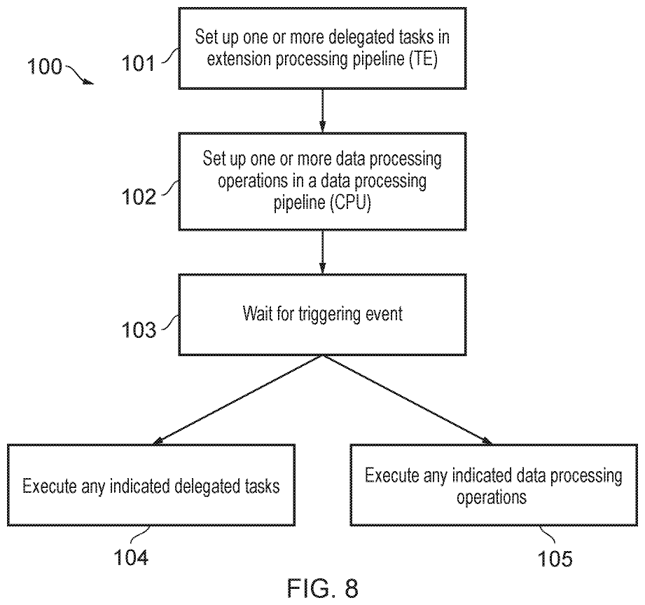

FIG. 8 shows a flowchart that illustrates a method of data processing; and

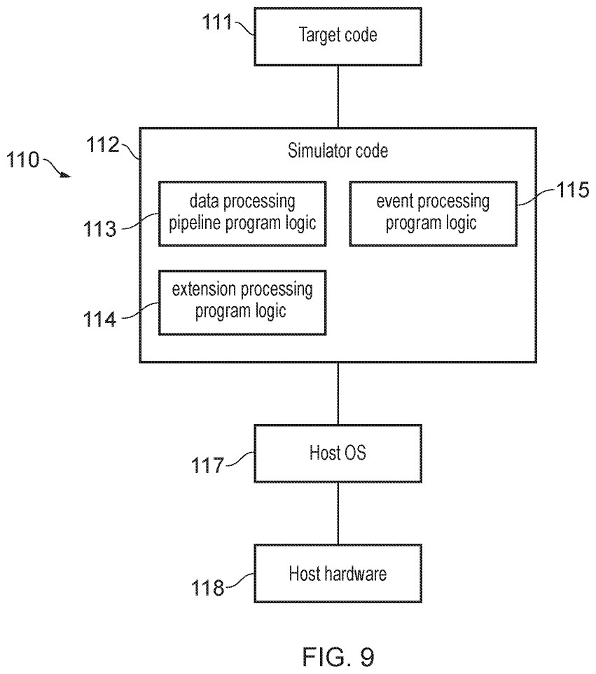

FIG. 9 illustrates a simulator implementation that may be used.

Before discussing the embodiments with reference to the accompanying figures, the following description of embodiments and associated advantages is provided.

In accordance with one example configuration there is provided an apparatus for data processing, comprising: a data processing pipeline configured to execute one or more data processing operations; extension processing circuitry associated with the data processing pipeline and configured to execute one or more delegated tasks; and event processing circuitry configured to cause at least one of the one or more delegated tasks and/or the one or more data processing operations to begin execution based on an event indicated by a linking instruction, wherein the extension processing circuitry is configured to perform the one or more delegated tasks asynchronously to the one or more data processing operations performed by the data processing pipeline.

An apparatus comprising a data processing pipeline can be required to perform a limitless variety of data processing operations as defined by the sequence of instructions provided to it. In order efficiently to perform those data processing operations, the data processing pipeline may be configured with a variety of functional units, each with a given specialised type of data processing ability, such as arithmetic logic units (ALUs), floating point (FP) units, load/store units, and so on. Yet even with such specialised functional units being provided as part of the data processing pipeline, the inventors of the present techniques have established that in some types of data processing, that is in certain programs (i.e. sequences of instructions), there can be particular functions which are frequently executed and which require an amount of processing, such that the provision of custom hardware dedicated to supporting these functions is worthwhile, since it could significantly impact the overall performance of the apparatus. In identifying such functions, two key properties were deemed to be relevant: a function's ubiquity (i.e. it can also be found in the many other use-cases) and a function's impact (i.e. the proportion of time spent executing such a function is a significant percentage of the overall runtime, such that improvements in its execution made a significant difference to the overall use-case). Such impactful, ubiquitous functions have been found to include tasks or functions such as memcpy, memset, compression, encryption, and string processing, although the present techniques are not limited to these particular examples. The present techniques provide extension processing circuitry that is associated with the data processing pipeline and is configured to set up such a function (a delegated task) for later execution, the delegated task being received from the data processing pipeline. Such extension processing circuitry may also be referred to as a threadlet extension (TE) herein. The sequence of operations it carries out to perform the defined function may also be referred to as a threadlet herein. The extension processing circuitry, although closely associated (tightly coupled) with the data processing pipeline, is configured to perform the delegated task asynchronously to the data processing operations performed by data processing pipeline. The data processing pipeline may also be referred to as the CPU herein. Threadlets are functions or collections of operations that can be executed asynchronously relative to other CPU activity once launched. The asynchronous operation of the extension processing circuitry with respect to the data processing pipeline is possible because, unlike some prior art techniques, the extension processing circuitry receives a directive or command from the thread currently executing on the CPU and performs the required operations independently, that is without requiring a stream of instructions from the CPU that directly control or influence its internal operation. The CPU is therefore free to continue executing other code and potentially reduce overall runtime by overlapping the execution of the instruction stream after the directive or command is sent to the extension processing circuitry with the operation of the extension processing circuitry. A linking instruction is used to indicate occurrence of an event that causes execution of a previously set up delegated task and/or the data processing operations beginning. That is to say that the linking instruction links operations in a dataflow graph. Because of the tight integration of the extension processing circuitry with the data processing pipeline, the extension processing circuitry can be launched rapidly and its state can be checked in a short amount of time (e.g. of the order of a few ns) relative to some prior art techniques, which would require a great many CPU cycles for launching commands or performing synchronisation operations. Because of the use of events to signal the chaining it is possible to avoid event-polling in which a task must continually ‘poll’ another task to see if it has completed yet or not.

In some examples, the event is a completion of a process performed by the one or more data processing operations or the one or more delegated tasks. In this way it is possible to ‘chain’ together groups of functions or operations with some groups of operations occurring in the data processing pipeline (CPU) and some groups of operations occurring in the extension processing circuitry. 15

In some examples, the one or more delegated tasks are delegated by the data processing pipeline. The data processing pipeline can, in these examples, cause a task to be delegated with the task being executed by the extension processing circuitry in an asynchronous operation.

In some examples, the linking instruction comprises an outbound event field to indicate the event. Based on that event (e.g. when that event occurs, which might be indicated by the linking instruction itself), execution can begin. In this instance, the event is said to be outbound from the perspective of the linking instruction because the linking instruction triggers (now or later) the occurrence of other delegated tasks and/or data processing operations.

In some examples, the apparatus for data processing comprises: decode circuitry configured to respond to a generative linking instruction as the linking instruction by generating one or more signals corresponding to occurrence of the event to cause the at least one of the one or more delegated tasks and/or the one or more data processing operations to begin execution. In a generative linking instruction, the instruction itself signals the occurrence of the event, which may immediately trigger one or more other delegated tasks and/or data processing operations to be performed. In particular, the identity of the delegated tasks and/or data processing operations that are triggered by such an event can be stored in the event processing circuitry, which can cause those delegated tasks and/or data processing operations to begin when the instruction is executed (provided any other pre-requisites are also met). The linking instruction is immediate because it immediately signals that the event has occurred.

In some examples, the apparatus for data processing comprises: decode circuitry configured to respond to a triggered linking instruction as the linking instruction by generating one or more signals to cause the at least one of the one or more delegated tasks and/or the one or more data processing operations to begin execution when the event occurs. Another form that the linking instruction can take is that of a triggered linking instruction in which the event is said to occur when a particular delegated task and/or data processing operation completes. The event may therefore occur at a later time. It will be appreciated that the apparatus may contain a single decode circuit that is able to decode instructions of various types-including both the triggered linking instruction and the generative linking instruction.

In some examples, the apparatus for data processing comprises: decode circuitry configured to respond to a setup instruction by generating one or more signals to perform setting up of the one of the one or more data processing operations and/or the one or more delegated tasks, wherein the setup instruction comprises an inbound event field configured to indicate the event. The setup instruction can be used hand-in-hand with the linking instruction. In particular, a setup instruction is used to indicate the circumstances under which a process (a delegated task or data processing operation) should execute. The linking instruction might be for a task to execute ‘now’ or it might be for a task to execute ‘when an event occurs’. A linking instruction is used to indicate the occurrence of an event. In a similar manner to the setup instruction, a linking instruction might indicate the occurrence of event ‘now’ or it might indicate the occurrence of an event ‘at some future time’ (such as when a process ends).

An event may be thought of as inbound or outbound from the perspective of an individual delegated task or data processing operation, but this clearly differs across each delegated task or data processing operation. For instance, from the perspective of a delegated task A that ‘emits’ an event, the event will be seen as outbound. However, from the perspective of a delegated task B that executions on occurrence of that event, the event will be seen as inbound. The inbound event field is therefore inbound from the perspective of the delegated task or data processing operation(s) to which the setup instruction refers.

In some examples, the setup instruction comprises the inbound event field and an outbound event field to indicate a further event whose occurrence is signalled when the one of the one or more data processing operations and/or the one or more delegated tasks is complete. In these examples, as well as specifying the inbound event field that can be used to indicate the event that is required for the data processing operation/delegated task to begin, an outbound event field is also provided, which indicates a further event that is signalled when the data processing operation/delegated task is completed. The setup instruction therefore indicates a process to be performed (e.g. a specific data processing operation/delegated task), what causes that process to begin and what happens when that process is ended. Such a setup instruction can therefore also act as a linking instruction.

In some examples, the setup instruction comprises the inbound event field and an outbound event field to indicate a further event whose occurrence is signalled when the one of the one or more delegated tasks is complete. Thus in these examples, the setup instruction that specifies both an inbound event and an outbound event is limited to the specification of delegated tasks.

In some examples, the setup instruction comprises a register field configured to indicate one or more registers that are used to transfer data in respect of the one of the one or more data processing operations and/or the one or more delegated tasks.

In some examples, the setup instruction comprises an immediate field configured to provide information regarding a type of the at least one of the one or more delegated tasks and/or the one or more data processing operations.

In some examples, the setup instruction comprises a location field configured to provide information regarding a location of the at least one of the one or more delegated tasks and/or the one or more data processing operations.

In some examples, the event is the further event. That is a delegated task and/or data processing operation's completion could cause the same delegated task and/or data processing operation to begin (albeit a different instantiation of the same delegated task and/or data processing operation). This could be true in the case of a self-linking group of functions, which might occur in a recursive or iterative function call for instance.

In some examples, the apparatus for data processing comprises: decode circuitry configured to respond to a synchronisation instruction by generating one or more signals to cause generation of a merged event in response to a plurality of events having occurred. Such an instruction makes it possible to state that the occurrence of several events is equivalent to one other event having occurred. This makes it possible to specify a plurality of events, all of which must occur, in order to cause another data processing operation and/or delegated task to begin execution.

In some examples, the synchronisation instruction comprises an inbound event field to indicate the plurality of events and an outbound event field to indicate the merged event.

In some examples, the apparatus for data processing comprises: a connection buffer configured to pass data between a completing task of the one or more delegated tasks and either: one of the one or more data processing operations or another of the one or more delegated tasks. The connection buffer makes it possible to pass data around. As a delegated task completes on the extension processing circuitry, it is possible for that data to be passed to either another delegated task on the extension processing circuitry or one of the one or more data processing operations. By providing hardware for this data passing it is possible to avoid the data passing taking place in software (e.g. via a stack, which could increase latency (by potentially going via memory) or via registers which would require synchronisation between the data processing pipeline and extension processing circuitry so as to not interrupt or interfere with any software that is executing). In practice, the amount of storage provided in the extension processing circuitry may be a function of how much data passing is permitted to take place and how many delegated tasks and data processing operations can operate simultaneously. As the amount of data passing increases and as the number of delegated tasks and data processing operations that can operate simultaneously increases, the amount of required storage increases too. In some examples, the final element that can be passed between processes is used to point to a memory location where further data can be obtained. Although this could introduce a memory latency, it would provide far more flexibility in terms of the amount of data that can be passed around.

In some examples, the linking instruction comprises a register field to indicate one or more registers that are used to transfer data with the connection buffer.

In some examples, the data processing pipeline and the extension processing circuitry are configured to perform multitasking of the one or more data processing operations and/or the one or more delegated tasks while staying at a same exception level. Traditionally, multitasking may take place with the use of some kind of supervisor software such as an operating system, which controls user-space applications below it. Through either explicit surrender of context or by time sharing, the exception level increases (e.g. to a more privileged state) and supervisory software changes context (context switches) thereby changing the application that is executing at the current moment in time before lowering the exception level back down (e.g. to a less privileged state). When the change happens regularly enough, this can give the illusion that multiple tasks are executing simultaneously. In practice, during a context switch, the executing context of the current application is saved, and the execution context of the next application is restored. In effect, each application is given the impression that the entire apparatus' processing resources belong to it. This process is problematic though because it generally requires the context to be saved at regular intervals. This may include the content of all architectural registers, stack pointer, program counters, link registers, and so on. This is particularly true if a timer-based scheduler is used, which could therefore cause interruption at any moment and therefore necessitates every item of state to be saved. In the present technique, the multitasking takes place at a single exception level (e.g. at the user-space level), which means that supervisor software is not needed. Instead, the multitasking may take place cooperatively so that data is explicitly passed between the data processing operations and/or delegated tasks. Because this transfer of data takes place explicitly, there is no need for supervisor software to intervene and there is no need for all items of state to be saved. This is much lighter weight than switching between threads which is itself lighter weight that switching between operating system processes or separate applications and therefore saves processing resources and time.

In some examples, the extension processing circuitry comprises storage circuitry to store one or more event dependencies of the one or more delegated tasks and the one or more data processing operations. Each of the one or more delegated tasks and the one or more data processing operations can have an event associated with them that must be performed in order to permit the execution of that delegated task/data processing operation. These can be stored in the extension processing circuitry, which receives notification of events, so that the extension processing circuitry can signal and control the start of execution.

In some examples, the apparatus for data processing comprises: decode circuitry configured to respond to a reset instruction by generating one or more signals to cause the one or more event dependencies to be deleted from the storage circuitry. The reset instruction can therefore be used to cancel the dependencies. This may take place when a particular set of tasks is completed and/or when the events that trigger particular data processing operations/delegated tasks are no longer to do so. In some examples, the reset instruction may be used to eliminate particular dependencies (e.g. the dependencies made in respect of a particular data processing operation or delegated task).

Particular embodiments will now be described with reference to the figures.

FIG. 1 schematically illustrates a data processing apparatus 10 according to some examples. The data processing apparatus 10 is schematically shown to have a pipelined configuration, which for the purposes of brevity and clarity is shown in a conceptual representation here. The illustrated pipeline stages comprise an instruction cache 11, a fetch stage 12, a decode stage 13, a micro-op cache 14, an issue stage 15, and a register access stage 16. A sequence of instructions is retrieved from memory (not shown) and cached in the instruction cache 11. The fetch stage 12 controls which instructions are retrieved as the sequence of instructions and these instructions are then decoded in the decode stage 13. This decoding essentially identifies the type of each instruction, as well as any further operands specified by the instruction, and generates control signals to control the remainder of the apparatus to perform the data processing operation(s) defined by the instruction. Decoding the instructions may comprise splitting an instruction into one or more micro-ops, and these micro-ops can be cached in the micro-op cache 14. The final stage of the pipeline before execution is the issue stage 15, where instructions (or micro-ops) are queued pending the availability of the register values they specify as operands and the corresponding functional unit of the data processing pipeline which will carry out the defined operation. Generally the data processing operation(s) defined by the instructions are carried out by the functional units that form part of the data processing pipeline, namely the load/store unit 17, the execute unit 18, and the execute unit 19. These latter execute units may for example be arithmetic logic units (ALUs), floating point units (FPUs), and so on. The functional units that form part of the data processing pipeline perform their data processing operations on data values which are provided from a set of registers (conceptually represented by the register access stage 16 in the figure) and result values of those data processing operations are returned to the set of registers. The load/store unit 17 is provided for the purpose of storing values from the set of registers to the memory system, of which only a level 1 cache 21 and a level 2 cache 22 are shown in the figure. The L1 cache 21 is private to the data processing apparatus 10 and the L2 cache 22 may be shared with another data processing apparatus, when part of a wider data processing system. The data processing apparatus 10 is also shown to comprise a branch unit 20, which monitors execution flow of the sequence of instructions and seeks to predict, based on previous execution history, whether a given branch will be taken or not. The predictions from the branch unit 20 inform the sequence of instructions caused to be fetched by the fetch stage 12.

The data processing apparatus 10 further comprises extension processing circuitry 23, which is provided to support efficient performance of one or more defined functions, which have been established to be impactful and ubiquitous for the data processing operations which this data processing apparatus 10 carries out. Example functions of this type have been found to include tasks or functions such as memcpy, memset, compression, encryption, and string processing, although the present techniques are not limited to these particular examples. The extension processing circuitry is closely associated with the data processing pipeline and is configured to perform the defined function (also referred to herein as a delegated task) in response to a delegation signal received from the data processing pipeline. The extension processing circuitry 23 is an example of a threadlet extension (TE) according to the present techniques. The sequence of operations it carries out to perform the defined function is referred to as a threadlet herein. The extension processing circuitry 23, although closely associated with the data processing pipeline, is configured to perform the delegated task asynchronously to the data processing operations performed by data processing pipeline. The data processing pipeline may also be referred to as the CPU herein. Threadlets are functions or collections of operations that can be executed asynchronously relative to other CPU activity once launched. A directive or command sent to the extension processing circuitry 23 to initiate the delegated task is generated in response to an extension start instruction defined for this purpose in the instruction set of the data processing pipeline. Thus, an extension start instruction progresses along the data processing pipeline in the manner that any other CPU instruction would, but when the decoding circuitry 13 identifies the extension start instruction it can signal directly to the extension processing circuitry 23. The close integration of the extension processing circuitry 23 with data processing pipeline is illustrated by the fact that the extension processing circuitry 23 has direct access to the load/store unit 17, and thus it shares the data processing pipeline's path to memory. The extension processing circuitry 23 also has access to the set of registers 16, such that for example, the extension start instruction can specify one or more registers as operands, and the values from these registers are then passed directly to the extension processing circuitry 23 in association with the command sent to initiate the delegated task. Upon completion of the task, results of the delegated task can be returned to the register values via an extension synchronisation instruction.

FIG. 2 schematically illustrates a data processing apparatus 30 according to some examples. It will be noted that the arrangement of components of the data processing apparatus 30 is similar to that of the components of the data processing apparatus 10 shown in FIG. 1. One difference is that whilst the data processing apparatus 10 of FIG. 1 is intended to represent an in-order processor, the data processing apparatus 30 is an out-of-order processor. As one consequence of this the data processing pipeline of the data processing apparatus 30 comprises a rename stage 35, allowing the data processing apparatus 30 to vary the order in which it executes instructions of the sequence of instructions, such that they can be executed in an order dictated by when their operands become available and the availability of the functional units, rather than the order in which they appear in the sequence. The illustrated pipeline stages comprise an instruction cache 31, a fetch stage 32, a decode stage 33, a micro-op cache 34, the rename stage 35, an issue stage 36, and a register access stage 37. A sequence of instructions is retrieved from memory (not shown) and cached in the instruction cache 31. Instructions pass through the data processing pipeline in the manner described above with reference to the data processing apparatus 10 of FIG. 1, with the further register renaming that is performed by the rename stage 35. The functional units of the data processing pipeline in this example are the load unit 38, the store unit 39, the FPU 41, the integer ALU 42, and the vector unit 43. The throughput of the FPU 41, the integer ALU 42, and the vector unit 43 is sufficient that a result cache 44 is provided an intermediary before results of their data processing are returned to the registers 37. A branch prediction unit 45 is also provided and its predictions inform the operation of the fetch stage 32.

The data processing apparatus 30 further comprises extension processing circuitry (“threadlet extension”) 49, which is provided to support efficient performance of one or more defined functions, which have been established to be impactful and ubiquitous for the data processing operations which this data processing apparatus 30 carries out. The extension processing circuitry 49 is closely associated with the data processing pipeline and is configured to perform the defined function in response to a delegation signal received from the data processing pipeline. In the example of FIG. 2, this delegation signal is shown emanating from the issue queue stage 36. Notably, this is after the rename stage 35, such that the extension processing circuitry 49 can operate with respect to the physical registers of the set of registers 37 according to the same mapping of architectural registers used for the rest of the apparatus. As in the example of FIG. 1, the data processing pipeline (instruction cache 31 through to the register read stage 37, the load/store units 38 and 39, and the functional units 41-45) may also be referred to as the CPU. The threadlet extension 49 operates asynchronously relative to other CPU activity once launched. A directive or command sent to the extension processing circuitry 49 to initiate the delegated task is generated in response to an instruction defined for this purpose in the instruction set of the data processing pipeline. The close integration of the extension processing circuitry 49 with data processing pipeline also apparent in this example by the fact that the extension processing circuitry 49 has direct access to the load unit 38 and the store buffer 40, and thus it shares the data processing pipeline's path to memory. The extension processing circuitry 49 also has access to the set of registers 37, such that for example, the extension start instruction can specify one or more registers as operands, and the values from these registers are then passed directly to the extension processing circuitry 49 in association with the command sent to initiate the delegated task. Note that the output of the branch prediction unit 45 is also provided to the extension processing circuitry 49. Upon completion of the task, results of the delegated task can be returned to the register values via an extension synchronisation instruction.

FIG. 3 schematically illustrates a data processing apparatus 50 according to some examples. This example provides a comparison to the examples of FIG. 1 and FIG. 2, in which examples the extension processing circuitry was closely embedded with the data processing pipeline, to the extent that those instances of extension processing circuitry may be considered to be within the CPU. In the example apparatus 50 of FIG. 3, the CPU 51 and the extension processing circuitry (threadlet extension) 52 are not as closely integrated. For example this is illustrated by the fact that each has its own path to memory, with an L1 cache 53 private to the CPU 51 and an L1 cache 54 private to the threadlet extension 52. They share the L2 cache 55. Nevertheless, the threadlet extension 52 remains tightly coupled to the CPU 51, and can be launched quickly when an extension start instruction is encountered in the CPU pipeline specifying the function this threadlet extension 52 performs. The threadlet extension 52 can get data directly from CPU registers at the start of its execution. Upon completion, it can return values via an extension synchronisation instruction. FIG. 3 also shows the threadlet extension 52 as having its own private TLB 56, in which it can cache currently used address translations. As a preparatory step before or associated with the delegation signal, content from the TLB 57 in the CPU 51 can be copied into the private TLB 56 in order to pre-warm this cache before the threadlet begins operation.

FIG. 4 is a state diagram illustrating an example set of states between which a extension processing circuitry (TE) transitions in some examples. Initially the TE is in an IDLE state 60. When an extension start (XSTART) instruction is encountered by the data processing pipeline, a delegation signal can cause the TE switches to the SETUP state 61. This may also require a signal indicating that the XSTART instruction has been committed to be asserted. In the SETUP state 61, certain actions necessary for preparing the TE can be performed, for example, in examples in which the TE has a separate path to memory (as in the case of FIG. 3), one setup task is the transfer of relevant entries currently in the CPU's TLB to a private TLB within the TE. This enables the TE to perform translations independently at a faster rate than if it were to rely entirely on the existing translation mechanism within the CPU. If the TE has been in a clock-gated or power-gated condition when in the IDLE state 60, the SETUP state 61 may also comprise the task of exiting the TE from that clock-gated or power-gated condition. Once the SETUP state 61 is complete (which may involve the occurrence of other events, as discussed below) the TE can switch to the RUNNING state 62. If the TE encounters a memory fault during its processing, it asserts a signal which will raise an interrupt within the CPU, causing it to stop executing the main thread and switch to a handler. The TE switches to the INTERRUPTED state 63. The address generating the fault is placed in a special syndrome system register and a bit in the Program Status Register (PSR) will be set enabling the handler to quickly determine the source of the fault. Setting a bit in the PSR makes communicating the resumption of the threadlet straightforward, because the handler can reset the relevant bit in the SPSR and when the CPSR is restored from the SPSR during exception return, the TE can detect the resetting of this bit and resume executing. The TE will also switch to the INTERRUPTED state 63 if the main thread gets switched out, e.g. during a context-switch initiated by the operating system. In the INTERRUPTED state 63, the TE may be clock-gated or power-gated, unless some other thread launches a new command directed at it or the associated thread returns resumes execution or the handler returns. The TE returns from the INTERRUPTED state 63 to the RUNNING state 62 via the RELOAD state 64 in which any context or state relevant to its execution, which was previously saved to memory, can be restored. This might be the case if another thread made use of a TE which was previously interrupted. Finally, when the extension reaches the end of the offloaded granule of computation (the delegated task) it moves to the IDLE state 60. The TE will advertise completion of the task, so that an extension synchronisation instruction (XSYNC) can pick up that “done” signal and, if required, provide a return value to a specified register. If the TE has any lingering data in its private caches it might also need to flush these entries upon completion.

An example of using threadlets is now set out. The programmer or compiler identifies functions whose execution in custom hardware (extension processing circuitry) satisfies the cost-benefit thresholds in their use-case. An instruction (such as XSTART) is used to launches a command within the designated CPU extension. An example use written in pseudo-code (for such an identified function “funcX”) is as follows:

```
funcA ( ) {
  ...
  XSTART {x0 − x3}, #imm_op //funcX (a, b, c, d);
  I1
  I2
  I3
  I4
  ...
  XSYNC x0, #imm_op
  ...
}
```

Thus, within the function funcA, the XSTART instruction initializes the CPU extension and transfers to the extension processing circuitry the parameters (a, b, c, d) for funcX, which are in registers x0, x1, x2, x3 respectively. The XSTART instruction in this example also specifies the immediate value #imm_op, which defines the specific function to be carried out. For example, whilst there might only be one instance of extension processing circuitry, it may be capable of performing more than one function, or at least more than one variant of a function, and the immediate value #imm_op can select the desired variant and/or function. In other examples there may be more than one instance of extension processing circuitry and the immediate value #imm_op can select between them. Depending on the setup, the extension could also automatically get a copy of relevant entries in the TLB. The extension processing circuitry then carries out the task required (funcX) and during its execution, the CPU is free to carry on executing other instructions I1, I2, I3, I4, etc. At some point in the future, the CPU executes an extension synchronisation instruction (XSYNC) which automatically checks whether the extension has completed or not. If it has not, for some variants of the extension synchronisation instruction, the CPU will wait for the delegated task to complete. Other variants of the extension synchronisation instruction (e.g. the XSYNCS variant) allow the CPU can carry on executing other code (if there are alternative routines available or stop executing and wait for completion of the extension (typically if there is nothing else to execute in the interim). There are a range of variations of XSTART and XSYNC proposed herein, and these are discussed in more detail with reference to the figures which follow.

It is desirable for the threadlets that execute on the TE to be able to be integrated with a threading mechanism that takes place on the CPU. In implementing such a system, it is desirable to avoid overheads-particularly since the size of the threadlets may be comparatively small (e.g. only one or two instructions long in some cases). Accordingly, the present techniques propose the use of a user-space threading mechanism for the multitasking. A user-space threading mechanism can be thought of as an efficient multitasking system with low overhead in which supervisor software such as an operating system need not manage the multitasking

Another overhead that can be reduced are so-called ‘polling loops’. The execution of a later process (which in the current disclosure, we use to refer to a delegated task executed on the TE or a data processing operation executed on the CPU) may be dependent on the execution of an earlier process. For instance, the earlier process might generate data that is consumed by the later process. A naïve way to implement this would be for the later process (or an orchestrating software routine or lightweight software scheduler) to poll the earlier process to determine whether it has completed or not. However, this is wasteful because the polling itself will consume processing resources until the earlier process completes. If the earlier process completes slowly then a large amount of resource will be wasted on testing the earlier process, to the detriment of other tasks; because other tasks need to wait for the slow-running task to complete before they can be scheduled (even if there are functional units available). The present techniques therefore propose the use of an event based system to signal whether a particular process can begin.

The present techniques therefore provide hardware in the TE that better support event-based execution. Since threadlets can be thought of as functions or collections of operations that can be spun off from the CPU and executed asynchronously to the CPU on the TE, it may be appropriate to carve out sections of a CPU's execution stream and have those separate sections trigger threadlets while also being sensitive to the execution of threadlets themselves. The execution stream is therefore broken up into microthreads and events can be sent between microthreads and threadlets. By writing programs in this manner, it is possible for a user to write programs in a scalable manner. In particular, programs can be written in such a way that they can take advantage of the available hardware, which may not be known to the programmer. For instance, without knowledge of the number of TEs or threadlet extension functional units (XUs) or other execution units found in the CPU.

FIG. 5 schematically illustrates a data processing apparatus 70 according to some examples. This example provides a comparison to the example of FIG. 3. In the example apparatus 70 of FIG. 3, the CPU 71 and the extension processing circuitry (threadlet extension TE) 74 have their own paths to memory, with an L1 cache 72 private to the CPU 71 and an L1 cache 80 private to the threadlet extension 74, with a prefetcher 81 to prefetch data into the L1 cache 80. A shared L2 cache 73 is provided. The CPU 71 and the threadlet extension 74 are tightly coupled and a threadlet or task can be delegated by the CPU 71. In this example, the act of setting up a process (e.g. a task on the threadlet extension 74 or a microthread on the CPU 71) is separated from the act of starting that process, which instead occurs in response to an event. The signalling of the events and the mechanism in which processes are started is controlled by the event processing unit (EPU) 75 that forms part of the threadlet extension 74. The threadlet extension 74 also includes a number of execution units (XU) 76, 77 that are used for executing tasks delegated by the CPU 71. In addition, a connection buffer 78 is provided, which allows for the passing of data between processes (microthreads and/or threadlets) via hardware. In particular, the connection buffer makes it possible for a number of XUs 76, 77 to receive data passed by a previous process and execute simultaneously, and yet still asynchronously from the CPU 71. In practice, the storage available to each process might be limited. For instance, it may be that each process (threadlet or microthread) is allowed to pass or receive four data values. This may of course be different in other examples. However, at least one of the values is used as a pointer to memory to indicate where more data items can be accessed. This is aided by the L1 cache 80 that is private to the threadlet extension 74. The threadlet extension 74 also features its own private TLB 79, in which it can cache currently used address translations.

The present techniques make use of two new types of instruction. Setup instructions are used to set up a delegated task and/or data processing operations by indicating which events cause that delegated task and/or data processing operations to begin execution. A linking instruction then causes the linkage: either by generating an event (a generative linking instruction) or by causing an event to be generated in response to something like the end of another delegated task and/or data processing operation(s) (a triggered linking instruction). Of course a particular instruction might be both a linking instruction and a setup instruction. Furthermore, delegated tasks and data processing operations might be treated differently. One particular example architecture might make use of the following instructions:
CSTART {x0-x3},x4,#imm,<event_ID_INBOUND>

Registers a microthread in the storage circuitry 90 of the TE 74. As with the XSTART instruction, the registers x0, x1, x2, and x3 can be used to provide input values to the microthread, which are provided via the connection buffer 78 as previously described. Register x4 is used to specify the location of the instructions to be executed as part of the microthread while the immediate value can be used to provide more specific information on the nature of the instructions to be executed. Finally, the event_ID_INBOUND field can be either a register or an immediate value and indicates the event that will cause the microthread to begin execution. Thus, when this event ID is triggered, the EPU 75 will cause the microthread to begin execution on the CPU 71.
CEND {x0-x3},<event_ID_OUTBOUND>

Is used to indicate the occurrence of the event_ID_OUTBOUND event and may be executed at the end of a microthread in order to signal to the EPU 75 that the specified event has occurred and that dependent microthreads or threadlets should begin execution. Output data is taken from registers x0, x1, x2, and x3 and provided to all the dependent processes via the connection buffer 78 as previously described.
XSTART {x0-x3},#imm,<event_ID_INBOUND>,<event_ID_OUTBOUND>

Is a variant of the previously described XSTART instruction. In this variant, the XSTART instruction does not begin execution of the specified threadlet, but instead sets it up for execution at a later time. Registers x0, x1, x2, and x3 can be used to specify input registers that can be used to pass registers into the threadlet. In addition, two event-based fields are provided. The first field is event_ID_INBOUND, which specifies the event that will cause the threadlet to begin execution. The second field is event_ID_OUTBOUND, which specifies the event that is generated when the threadlet completes. This can be used to trigger other microthreads or threadlets.
CSYNC {#8-#11},<event_ID_OUTBOUND>

Can be used to merge several events together and can be used to indicate that a particular process is predicated on several other events triggering. In particular, the first field is used to provide a list of events that are required to occur and the second field is used to specify an outbound event that is equivalent to that list of events occurring. This outbound event can then be used as a substitute or proxy for the list of events provided in the first field. Clearly in this case it will be necessary for the programmer to make use of memory in order to transfer data from the multiple inbound events to the outbound events.
CSYNC x5, x6, <event_ID_OUTBOUND>

Similar to the CSYNC instruction specified above, but this variant allows for a dynamic range to be specified. In particular, the first task of the range is provided in register x5 and the second task of the range is provided in register x6. When the full set of events within this range occur, the outbound event specified by event_ID_OUTBOUND is signalled.
EPURESET [x1]

Is used to reset some or all of the list of event dependencies in the storage circuitry 90 of the EPU 71. In particular, if it is no longer desired for any events to trigger the occurrence of a microthread or threadlet, then executing the EPURESET with no further parameters causes all dependencies to be erased. Alternatively, by providing the x1 parameter, it is possible to specify particular dependencies that should be erased. In this example, the register x1 is used to indicate a set of event IDs that should no longer trigger processes from being executed-those processes therefore become (effectively) unscheduled. Other techniques are of course also applicable. For instance, where processes have a unique identifier, it is possible to specify the identifiers that should be eliminated.

It will be appreciated that such an instruction set architecture is just one example. For example, there is no reason why CSTART could not include both inbound events and outbound events in the same manner as XSTART or why there couldn't be an XEND instruction in much the same way as the CEND instruction. The inventors of the present technique have merely favoured the above configuration.

FIG. 6 illustrates an example of the EPU 75. In this example, the EPU is provided with storage circuitry 90 in order to store dependencies between the processes (microthreads and threadlets) so that the occurrence of an event can cause other processes to begin execution. New entries can be added to the EPU as a consequence of setup instructions like XSTART and CSTART. In this example, the storage circuitry indicates whether a process is a threadlet or a microthread (so that it knows where the process should be executed). An ID is also provided to indicate what process is being performed. In the case of a threadlet, this is an immediate value whereas in the case of a microthread, this is a location in memory of instructions or an operation. In each case, an event ID is provided that indicates the event that causes the process to begin execution and in the case of a threadlet, an outbound event is specified that is signalled when the threadlet has completed execution.

Note that in one of the examples shown in FIG. 6, a threadlet has the same inbound event (6) as its outbound event (6) thereby resulting in a looped threadlet. That is, the threadlet will continue to run until the EPURESET instruction is executed (e.g. by the CPU).

The list of dependencies can also be used to control the lifetime of data stored within the connection buffer 78. In particular, the storage circuitry 90 can be used to indicate dependency links between processes and it is therefore known how many later processes will consume data that is produced by an earlier process. Each set of data produced by a producer task can be stored with a countdown counter, which is decremented each time the data is consumed by one of the later processes with the data being deleted when it reaches 0.

FIG. 7A illustrates an example of a dataflow graph containing a number of microthreads (rectangles) and threadlets (circles) that collectively make up a program. Each of the processes is executed in user-space and execution can pass between the processes without the aid of supervisor software (which does not mean that such software does not exist-merely that it need take no part in this multitasking). The processes (microthreads and threadlets) are connected with arrows that indicate the direction of execution. The labels on the arrows indicate the event ID that is produced or consumed by each process.

So in this example, microthread A is executed and causes event 1 to be produced. This is consumed by microthread B and threadlet C. Microthread B, after being executed, produces event 2, which is consumed by threadlet D. The execution of threadlet D then produces event 4, which is consumed by threadlet F, microthread G, and threadlet H. On execution, threadlet F produces event 6, microthread G produces event 7, and threadlet H produces event 8. Threadlet C produces (at the end of its execution) event 3, which is consumed by microthread E. Microthread E produces, from its execution, event 5, which is consumed by threadlet I. Threadlet I, on execution, produces event 9. Finally, events 6 (produced by F), 7 (produced by G), 8 (produced by H), and 9 (produced by I) are consumed by threadlet J, which emits event 11 on execution.

FIG. 7B illustrates how the program illustrated by the dataflow graph of FIG. 7A might be set up for later execution. It will be noted that the series of instructions executed is a series of CSTART, XSTART, and CSYNC instructions that therefore merely set up processes (microthreads and threadlets). No actual execution is made to happen at this stage.

Line 1 is a CSTART instruction that causes the setup of a microthread ‘main’ with the immediate value #imm. The instruction specifies that that this microthread should execute when event 11 occurs.

Line 2 is a CSTART instruction that causes the setup of a microthread ‘processB’ with the immediate value #imm. The instruction specifies that this microthread should execute when event 1 occurs.

Line 3 is an XSTART instruction that causes the setup of a threadlet ‘processC’ with the immediate value #imm. The instruction specifies that this threadlet should execute when event 1 occurs and when the process is complete, it produces an event 3.

Line 4 is an XSTART instruction that causes the setup of a threadlet ‘processD’ with the immediate value #imm. The instruction specifies that this threadlet should execute when event 2 occurs and when the process is complete, it produces an event 4.

Line 5 is a CSTART instruction that causes the setup of a microthread ‘processE’ with the immediate value #imm. The instruction specifies that this microthread should execute when event 3 occurs.

Line 6 is a CSTART instruction that causes the setup of a microthread ‘processG’ with the immediate value #imm. The instruction specifies that this microthread should execute when event 4 occurs.

Line 7 is an XSTART instruction that causes the setup of a threadlet ‘processJ’ with the immediate value #imm. The instruction specifies that this threadlet should execute when event 10 occurs and when the process is complete, it produces an event 11.

Line 8 is an CSYNC instruction. As explained above, this effectively ‘merges’ events 6, 7, 8, and 9 into a virtual event ‘10’. The occurrence of event 10 is therefore equivalent to the occurrence of all of events 6-9 and this allows a process to be dependent on the occurrence of events 6-9 while specifying only a single event (10).

Line 9 is an XSTART instruction that causes the setup of a threadlet ‘processF’ with the immediate value #imm. The instruction specifies that this threadlet should execute when event 4 occurs and when the process is complete, it produces an event 6.

Line 10 is an XSTART instruction that causes the setup of a threadlet ‘processH’ with the immediate value #imm. The instruction specifies that this threadlet should execute when event 4 occurs and when the process is complete, it produces an event 8.

Line 11 is an XSTART instruction that causes the setup of a threadlet ‘processI’ with the immediate value #imm. The instruction specifies that this threadlet should execute when event 5 occurs and when the process is complete, it produces an event 9.

All of these instructions result in the setup of the processes.

Examples of processes A, B, E, and G (the microthreads) are also illustrated in FIG. 7B. In particular, processA runs some code and then signals the occurrence of event 1 (while enabling registers x0 to x3 to be output). processB runs some code and then signals the occurrence of event 2 (while enabling registers x0 to x3 to be output). processE runs some code and then signals the occurrence of event 5 (while enabling registers x0 to x3 to be output). Finally, processG runs some code and then signals the occurrence of event 7 (while enabling registers x0 to x3 to be output).

The preamble to the main process and the main process itself might appear as follows:
MOV x20, #10
   main:
. . .
SUBS x20, x20, #1
B.NE processA
which initialises a loop to execute processA 10 times, which in turn causes the execution sequence illustrated in FIG. 7A to occur.

Note that the ending of FIG. 7B includes the instruction EPURESET, which erases the dependencies some time later. That is, further occurrence of any of events 1-11 will no longer cause any of processes A-I to occur.

FIG. 8 illustrates a flow chart 100 in accordance with some examples. At a step 101, one or more delegated tasks are set up in the extension processing pipeline (e.g. the 74). In step 102, one or more data processing operations are set up in a data processing pipeline (e.g. the CPU 71). Then at step 103, a triggering event is awaited. In practice, during this time, other threadlets or microthreads may execute. When the event is signalled, then any indicated delegated tasks may begin execution at step 104 and any indicated data processing operations may begin execution at step 105. These can occur asynchronously (and in parallel).

FIG. 9 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 118, optionally running a host operating system 117, supporting the simulator program 112. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 730), some simulated embodiments may make use of the host hardware, where suitable.

The simulator program 112 may be stored on a computer-readable storage medium (which may be a non-transitory medium), and provides a program interface (instruction execution environment) to the target code 111 (which may include applications, operating systems and a hypervisor) which is the same as the interface of the hardware architecture being modelled by the simulator program 112. Thus, the program instructions of the target code 111 may be executed from within the instruction execution environment using the simulator program 112, so that a host computer 118 which does not actually have the hardware features of the apparatuses 10, 30, 50, 70 discussed above can emulate these features.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. An apparatus for data processing, comprising:
a data processing pipeline configured to execute one or more data processing operations;
extension processing circuitry associated with the data processing pipeline and configured to execute one or more delegated tasks; and
event processing circuitry configured to cause at least one of the one or more delegated tasks and/or the one or more data processing operations to begin execution based on an event indicated by a linking instruction, wherein
the extension processing circuitry is configured to perform the one or more delegated tasks asynchronously to the one or more data processing operations performed by the data processing pipeline.

2. The apparatus according to claim 1, wherein
the event is a completion of a process performed by the one or more data processing operations or the one or more delegated tasks.

3. The apparatus according to claim 1, wherein
the one or more delegated tasks are delegated by the data processing pipeline.

4. The apparatus according to claim 1, wherein
the linking instruction comprises an outbound event field to indicate the event.

5. The apparatus according to claim 1, comprising:
decode circuitry configured to respond to an generative linking instruction as the linking instruction by generating one or more signals corresponding to occurrence of the event to cause the at least one of the one or more delegated tasks and/or the one or more data processing operations to begin execution.

6. The apparatus according to claim 1, comprising:
decode circuitry configured to respond to a triggered linking instruction as the linking instruction by generating one or more signals to cause the at least one of the one or more delegated tasks and/or the one or more data processing operations to begin execution when the event occurs.

7. The apparatus according to claim 1, comprising:
decode circuitry configured to respond to a setup instruction by generating one or more signals to perform setting up of the one of the one or more data processing operations and/or the one or more delegated tasks, wherein
the setup instruction comprises an inbound event field configured to indicate the event.

8. The apparatus according to claim 7, wherein
the setup instruction comprises the inbound event field and an outbound event field to indicate a further event whose occurrence is signalled when the one of the one or more data processing operations and/or the one or more delegated tasks is complete.

9. The apparatus according to claim 7, wherein
the setup instruction comprises the inbound event field and an outbound event field to indicate a further event whose occurrence is signalled when the one of the one or more delegated tasks is complete.

10. The apparatus according to claim 7, wherein
the setup instruction comprises a register field configured to indicate one or more registers that are used to transfer data in respect of the one of the one or more data processing operations and/or the one or more delegated tasks.

11. The apparatus according to claim 7, wherein
the setup instruction comprises an immediate field configured to provide information regarding a type of the at least one of the one or more delegated tasks and/or the one or more data processing operations.

12. The apparatus according to claim 7, wherein
the setup instruction comprises a location field configured to provide information regarding a location of the at least one of the one or more delegated tasks and/or the one or more data processing operations.

13. The apparatus according to claim 8, wherein
the event is the further event.

14. The apparatus according to claim 1, comprising:
decode circuitry configured to respond to a synchronisation instruction by generating one or more signals to cause generation of a merged event in response to a plurality of events having occurred.

15. The apparatus according to claim 14, wherein
the synchronisation instruction comprises an inbound event field to indicate the plurality of events and an outbound event field to indicate the merged event.

16. The apparatus according to claim 1, comprising:
a connection buffer configured to pass data between a completing task of the one or more delegated tasks and either: one of the one or more data processing operations or another of the one or more delegated tasks.

17. The apparatus according to claim 15, wherein
the linking instruction comprises a register field to indicate one or more registers that are used to transfer data with the connection buffer.

18. The apparatus according to claim 1, wherein
at least one of the data processing pipeline and the extension processing circuitry are configured to perform multitasking of the one or more data processing operations while staying at a same exception level.

19. The apparatus according to claim 1 wherein
the extension processing circuitry comprises storage circuitry to store one or more event dependencies of the one or more delegated tasks and the one or more data processing operations.

20. The apparatus according to claim 19, comprising:
decode circuitry configured to respond to a reset instruction by generating one or more signals to cause the one or more event dependencies to be deleted from the storage circuitry.

21. A data processing method, comprising:
setting up one or more data processing operations in a data processing pipeline;
setting up one or more delegated tasks in extension processing circuitry associated with the data processing pipeline; and
causing at least one of the one or more delegated tasks and one or more data processing operations to begin execution based on an event indicated by a linking instruction, wherein
the one or more delegated tasks are executed asynchronously to the one or more data processing operations performed by the data processing pipeline.

22. A computer program for controlling a host data processing apparatus to provide an instruction execution environment comprising:
data processing pipeline program logic configured to execute one or more data processing operations;
extension processing program logic associated with the data processing pipeline program logic and configured to execute one or more delegated tasks; and
event processing program logic configured to cause at least one of the one or more delegated tasks and/or the one or more data processing operations to begin execution based on an event indicated by a linking instruction, wherein
the extension processing program logic is configured to perform the one or more delegated tasks asynchronously to the one or more data processing operations performed by the data processing pipeline program logic.

23. A non-transitory computer-readable medium to store computer-readable code for fabrication of an apparatus for data processing, comprising:
a data processing pipeline configured to execute one or more data processing operations;
extension processing circuitry associated with the data processing pipeline and configured to execute one or more delegated tasks; and
event processing circuitry configured to cause at least one of the one or more delegated tasks and/or the one or more data processing operations to begin execution based on an event indicated by a linking instruction, wherein
the extension processing circuitry is configured to perform the one or more delegated tasks asynchronously to the one or more data processing operations performed by the data processing pipeline.
